(19) United States
(12) Patent Application Publication
(10) Pub. No.: US 2016/0280500 A1
(43) Pub. Date: Sep. 29, 2016

(54) SLIT LINE MAKING MACHENISM FOR FILM ROLL/BAG-ON-A-ROLL MAKING MACHINE

(71) Applicant: COSMO MACHINERY CO., LTD., New Taipei (TW)

(72) Inventor: Chun Liang Lin, New Taipei City (TW)

(21) Appl. No.: 14/849,182

(22) Filed: Sep. 9, 2015

Related U.S. Application Data
(63) Continuation-in-part of application No. 14/665,895, filed on Mar. 23, 2015.

(51) Int. Cl. B65H 35/08; B26D 1/62

(52) U.S. Cl. CPC B65H 35/08; B26D 1/626

(57) ABSTRACT

A slit line making mechanism includes a first roller, a second roller, a feeder motor, a slit cutter, and a slit cutter motor. The feeder motor is controlled to rotate the second roller and then the first roller after insertion of a lead end of a film roll/bags-on-a-roll through the gap between the first roller and the second roller and the gap between the second roller and the slit cutter, thereby delivering the film roll/bags-on-a-roll to a reel replacement unit for dispensing. The feeder motor is controlled to rotate the second roller in delivering the film roll/bags-on-a-roll, and the slit cutter motor is controlled to rotate the slit cutter each time the second roller is rotated to deliver the film roll/bags-on-a-roll to a predetermined distance, causing the slit cutter to make a slit line on the film roll/bags-on-a-roll.

### CROSS-REFERENCE TO RELATED APPLICATION

The present invention is a continuation-in-part of patent application Ser. No. 14/665,895, filed on Mar. 23, 2015.

### BACKGROUND OF THE INVENTION

1. Field of the Invention

The present invention relates to plastic film/sheet of bags packaging technology and more particularly, to a slit line making mechanism for use in a film roll/bags-on-a-roll making machine for creating slit lines on a film roll/bags-on-a-roll.

2. Description of the Related Art

Commercial plastic wraps or food wraps are commonly provided in rolls and packed in individual boxes, and typically used for sealing food items in containers to keep them fresh over a longer period of time. A commercial plastic wrap box has a serrated cutter blade attached to a front panel of a cover of the box body thereof. When in use, the user needs to pull out the front end of the wrap-on-a-roll out of the box body with the fingers and then bias the front end of the wrap-on-a-roll against the serrated cutting edge of the serrated cutter blade, enabling the plastic wrap to be cut off by the serrated cutter blade at the selected length. However, when dispensing the plastic wrap, the user's fingers can easily be injured by the serrated cutter blade. Further, adding the serrated cutter blade to the box body greatly increases the cost of the plastic wrap box.

If a wrap-on-a-roll has slit lines thereon, a user can separate a piece of plastic wrap from the wrap-on-a-roll directly by hand. In this case, the plastic wrap box does not need to provide a serrated cutter blade, avoiding accidental finger injuries and saving the manufacturing cost.

In fabrication of commercial wraps-on-a-roll, a large size wrap-on-a-roll is dispensed into multiple small size wraps-on-a-roll by a dispensing mechanism in a wrap-on-a-roll making machine for further selling or application.

However, conventional film roll, bags-on-a-roll or wraps-on-a-roll making machines are not equipped with a slit line making mechanism, not cable of making slit film rolls, slit bags-on-a-roll or slit wraps-on-a-roll.

Therefore, conventional film roll, bags-on-a-roll or wraps-on-a-roll making machines are still not satisfactory in function.

Therefore, it is desirable to provide a slit film roll/bags-on-a-roll/wrap-on-a-roll making machine, which is practical for making slit film rolls, slit bags-on-a-roll or slit wraps-on-a-roll.

### SUMMARY OF THE INVENTION

The present invention has been accomplished under the circumstances in view. It is therefore one object of the present invention to provide a slit line making mechanism, which is practical for use in a film roll/bags-on-a-roll making machine for creating slit lines on a film/sheet of bags.

To achieve this and other objects of the present invention, a slit line making mechanism is adapted for use in a film roll/bags-on-a-roll roll-up machine for creating slit lines on a film roll/bags-on-a-roll. The slit line making mechanism comprises a first roller, a second roller disposed adjacent to one side of the first roller and rotatable to cause rotation of the first roller, a feeder motor adapted for rotating the second roller, a slit cutter disposed adjacent to one side of the second roller, and a slit cutter motor adapted for rotating the slit cutter. The feeder motor is controllable to rotate the second roller and then the first roller after insertion of a lead end of a film roll/bags-on-a-roll through the gap between the first roller and the second roller and the gap between the second roller and the slit cutter, causing the film roll/bags-on-a-roll to be delivered to a reel replacement unit of the film roll/bags-on-a-roll roll-up machine for dispensing. The feeder motor and the slit cutter motor are respectively and electrically connected to a control unit of the film roll/bags-on-a-roll roll-up machine. The feeder motor is controllable by the control unit to rotate the second roller in delivering the film roll/bags-on-a-roll. The slit cutter motor is controllable by the control unit to rotate the slit cutter each time the second roller is rotated to deliver the film roll/bags-on-a-roll to a predetermined distance, causing the slit cutter to make a slit line on the film roll/bags-on-a-roll.

Through the slit lines that are made on the film roll/bags-on-a-roll, a user can separate pieces of film/bags from the film roll/bags-on-a-roll individually by hand without using a serrated cutter blade, saving the cost and avoiding accidental finger injuries.

### BRIEF DESCRIPTION OF THE DRAWINGS

FIG. 1 is schematic side view of a slit line making mechanism used in a film roll/bags-on-a-roll making machine in accordance with the present invention.

FIG. 2 is an oblique top elevational view of a part of the slit film roll/bags-on-a-roll making machine in accordance with the present invention.

FIG. 3 corresponds to FIG. 2, illustrating the internal structural arrangement of the slit film roll/bags-on-a-roll making machine after removal of the machine base.

FIG. 4 corresponds to FIG. 4 when viewed from another angle.

FIG. 5 is an oblique top elevational view of a part of the present invention, illustrating the structural arrangement of the slit film roll/bags-on-a-roll making machine and the material holding unit.

FIG. 6 is an oblique top elevational view of a part of the present invention, illustrating the structural arrangement of the reel displacement unit.

FIG. 7 is an exploded view of the second roller and the slit cutter.

FIG. 8 is an oblique top elevational assembly view of the second roller and the slit cutter.

FIG. 9 is a schematic drawing illustrating a slit line created on a film roll/bags-on-a-roll according to the present invention.

### DETAILED DESCRIPTION OF THE PREFERRED EMBODIMENT

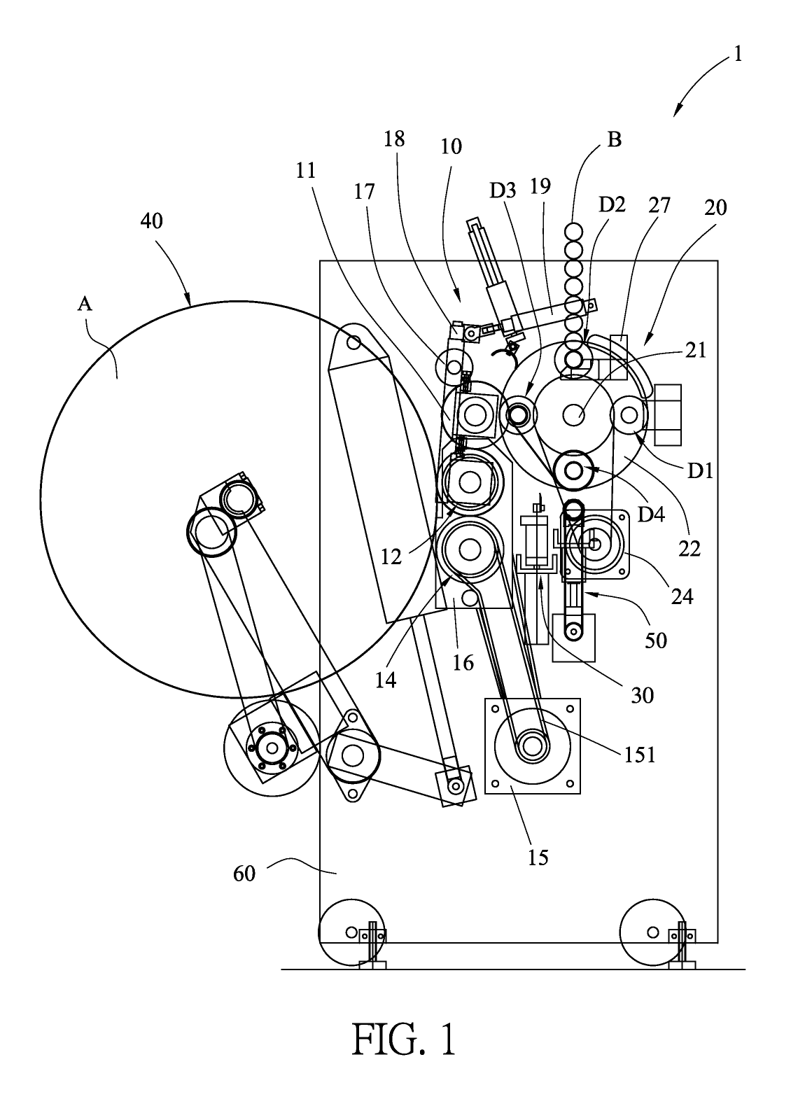

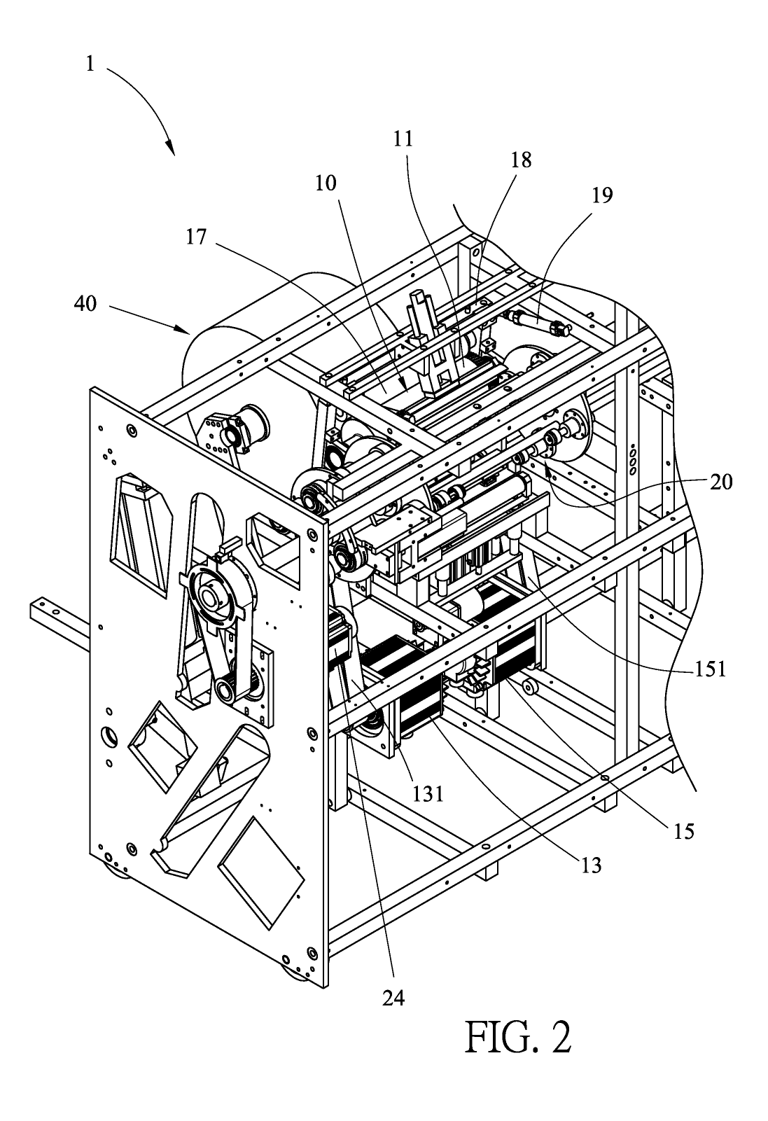

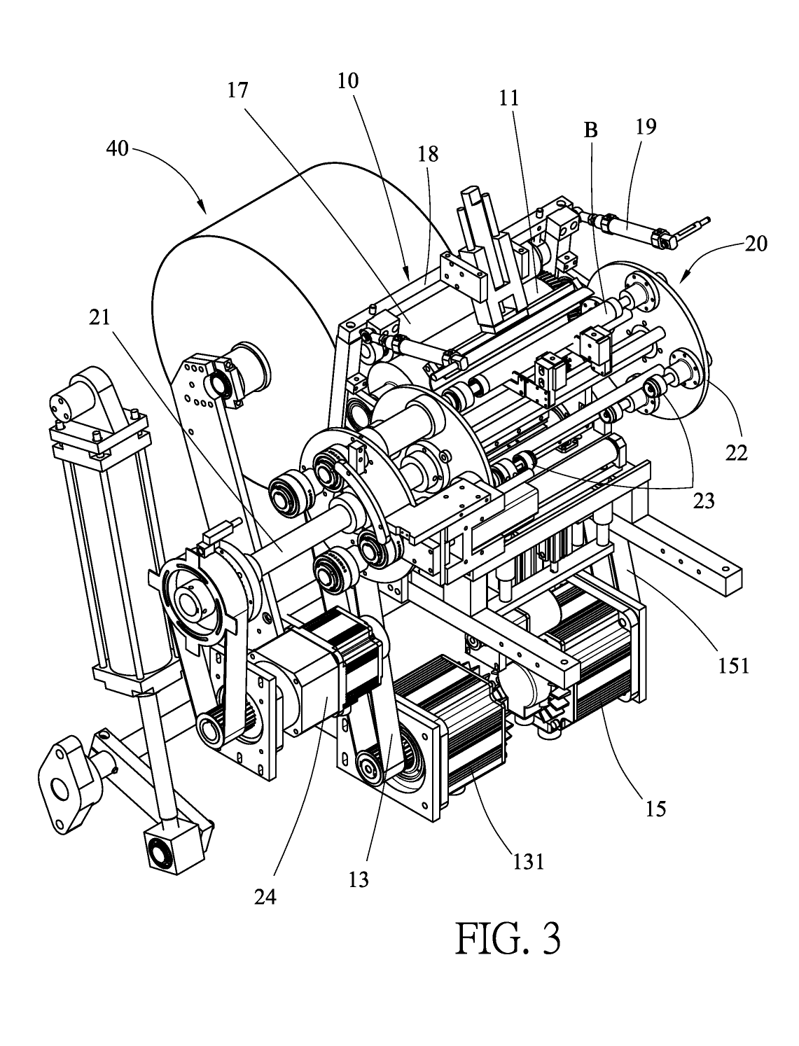

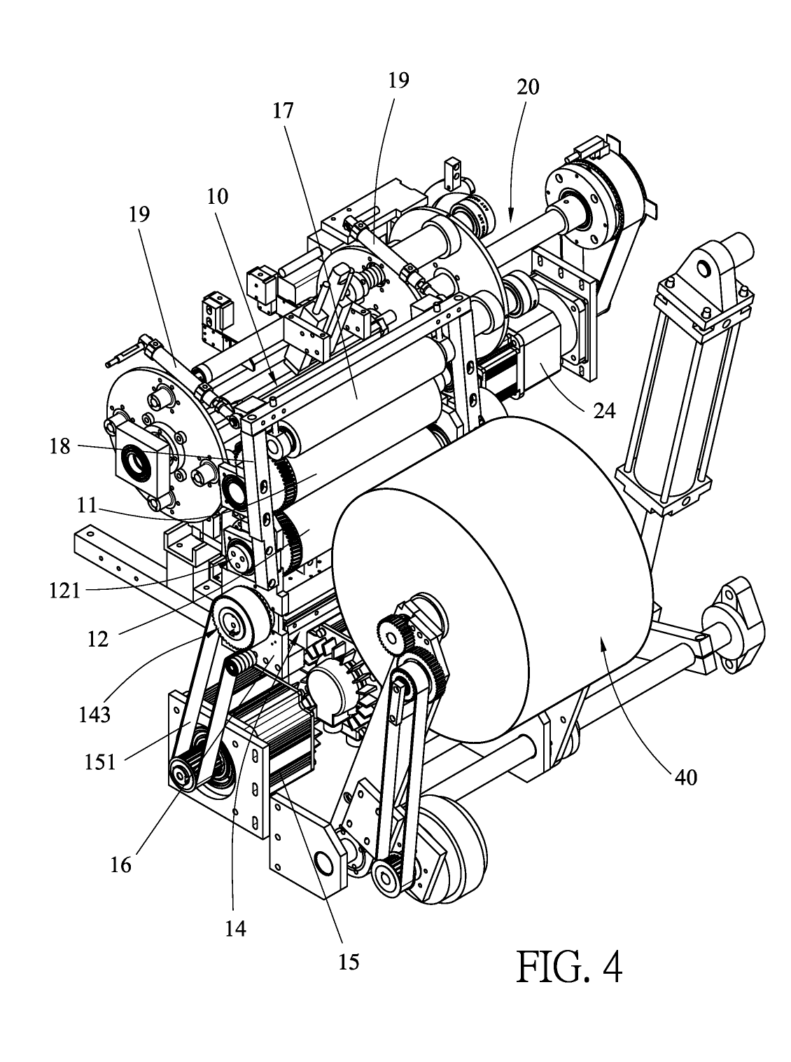

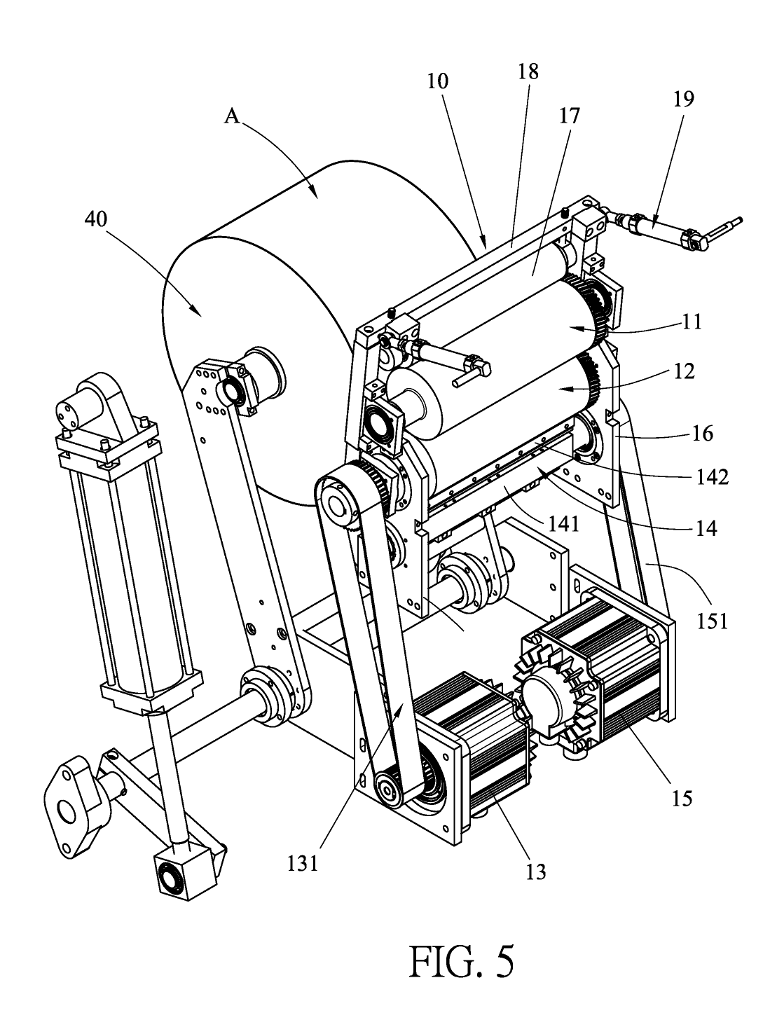

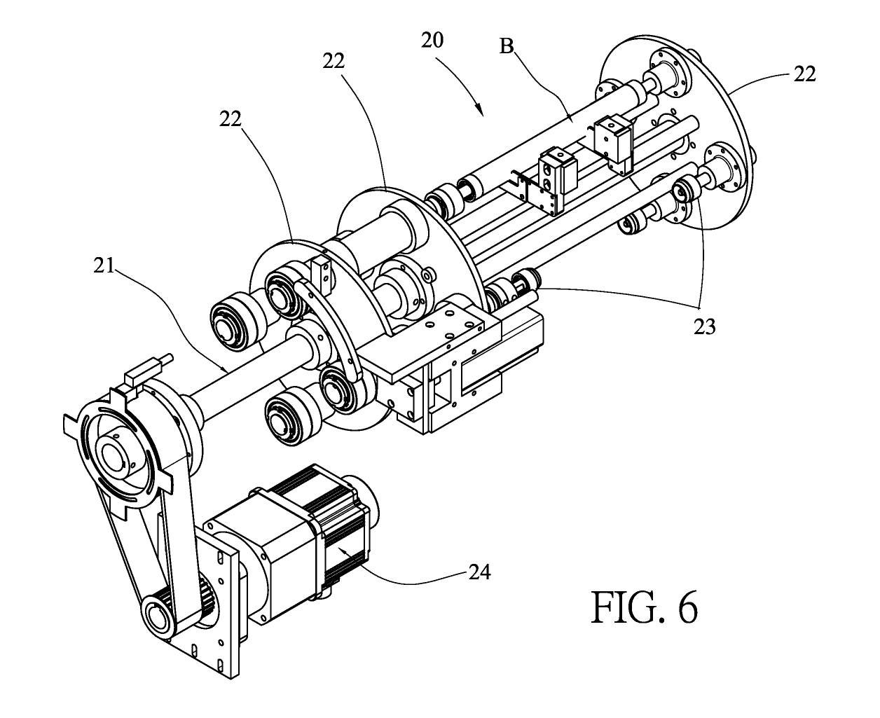

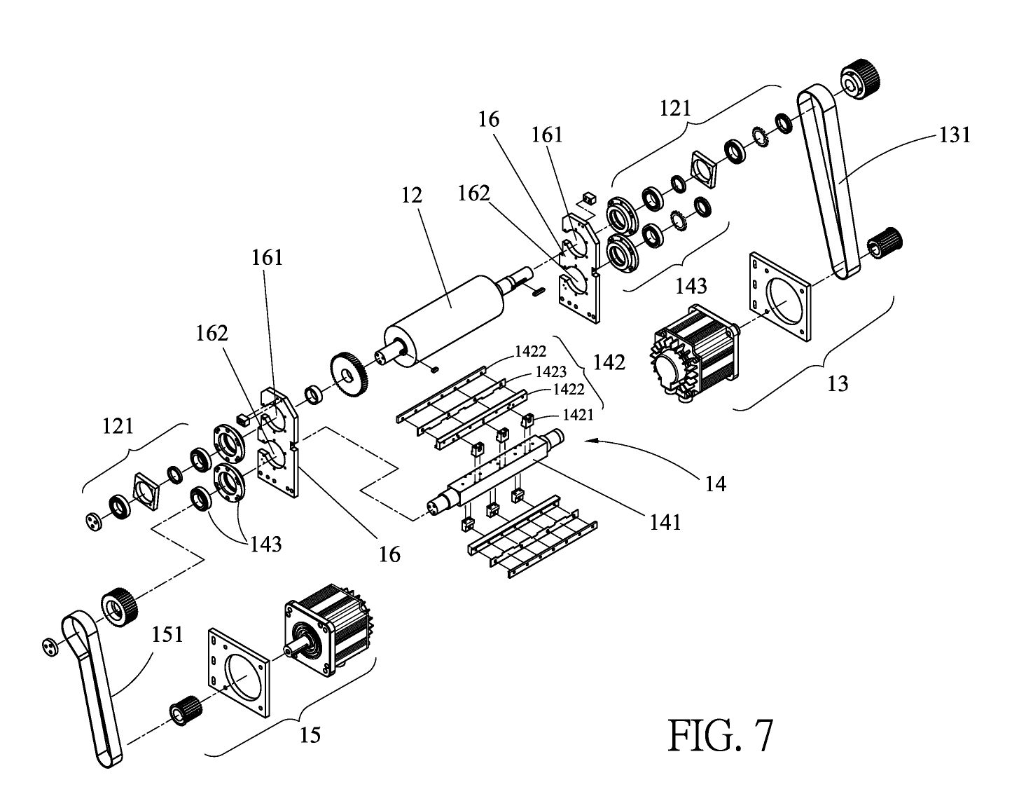

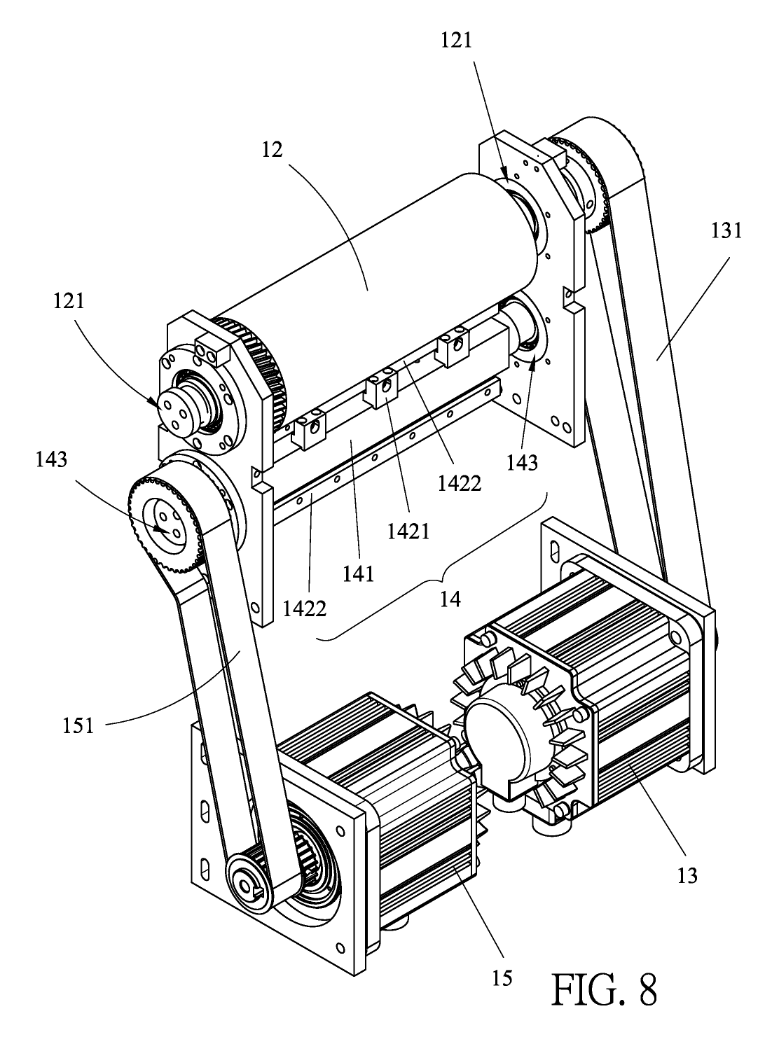

Referring to FIGS. 1-8, a slit line making mechanism 10 in accordance with the present invention is adapted for use in a film roll/bags-on-a-roll roll-up machine 1. The film roll/bags-on-a-roll roll-up machine 1 comprises a reel replacement unit 20, a cut-off mechanism 30, a material holding unit 40, a smoothing unit 50, and a machine base 60. The slit line making mechanism 10 structurally comprises first roller 11, a second roller 12 disposed adjacent to and rotatable to rotate the first roller 11, a feeder motor 13 adapted for rotating the second roller 12, a slit cutter 14 disposed near the second roller 12 at one lateral side, a slit cutter motor 15 adapted for rotating the slit cutter 14. Further, belt, chain, rope, link or any other suitable transmission mechanisms are respectively provided between the feeder motor 13 and the second roller 12 and between the slit cutter motor 15 and the slit cutter 14, enabling the slit cutter motor 15 to rotate the slit cutter 14 or the feeder motor 13 to rotate the second roller 12.

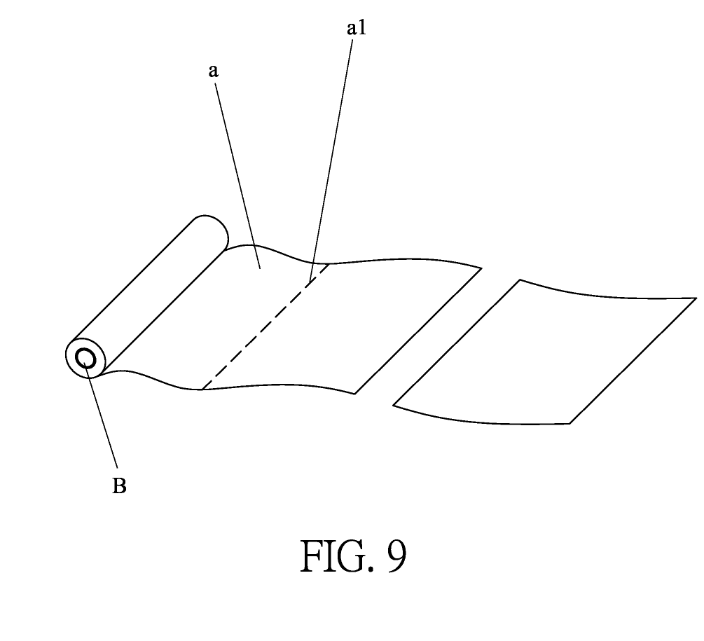

A film roll/bags-on-a-roll A to be dispensed is loaded on the material holding unit 40, and then the lead end of the film roll/bags-on-a-roll A is inserted through the gap between the first roller 11 and the second roller 12 and the gap between the second roller 12 and the slit cutter 14. In this embodiment, the film roll/bags-on-a-roll A is a wrap-on-a-roll. At this time, start up the feeder motor 13 to rotate the second roller 12 and then the first roller 11, delivering the film roll/bags-on-a-roll A to the reel replacement unit 20 for dispensing. A control unit (not shown) is electrically connected to the feeder motor 13 and the slit cutter motor 15, and operable to control the feeder motor 13 in driving the second roller 12 to deliver the film roll/bags-on-a-roll A. Each time the second roller 12 is rotated to deliver the film roll/bags-on-a-roll A to a predetermined distance, the control unit drives the slit cutter motor 15 to rotate the slit cutter 14, causing the slit cutter 14 to make a slit line A1 on the film roll/bags-on-a-roll A (as shown in FIG. 9). This slit line A1 can be a line of dents or perforations. In this embodiment, the slit line A1 is a line of dents.

Referring to FIG. 9, the invention has the advantages and effects as follows. During the operation of the film roll/bags-on-a-roll roll-up machine 1 to dispense one film roll/bags-on-a-roll A into a small size film roll/bags-on-a-roll a, the slit line making mechanism 10 in the film roll/bags-on-a-roll roll-up machine 1 efficiently creates slit lines al on each dispensed small size film roll/bags-on-a-roll a (wrap-on-a-roll) at a predetermined interval. Through the slit lines al, a user can separate pieces of film/bags from the small size film roll/bags-on-a-roll a individually by hand without using a serrated cutter blade, saving the cost and avoiding accidental finger injuries.

Referring to FIGS. 1 and 7-9, in one example of the present invention, the feeder motor 13 and the slit cutter motor 15 are server motors; the control unit (not shown) is operable to accurately control rotation of the slit cutter motor 15 subject to rotation of the feeder motor 13, for example, controlling the slit cutter motor 15 to rotate through one turn each time the feeder motor 13 is rotated through 5 turns, creating slit lines A1 on the film roll/bags-on-a-roll A at a fixed distance. Specifically, the distance between each two adjacent slit lines al on the film roll/bags-on-a-roll A is controlled subject to the rotational speed difference between the feeder motor 13 and the slit cutter motor 15.

In this embodiment, the slit cutter 14 comprises a cutter holder 141 and two cutter sets 142. Each cutter set 142 comprises a plurality of mounting blocks 1421, two clamping plates 1422, and a cutter blade 1423. The mounting blocks 1421 are affixed to the cutter holder 141. The clamping plates 1422 hold the cutter blade 1423 therebetween and detachably fastened with the cutter blade 1423 to the mounting blocks 1421. Thus, the clamping plates 1422 protect the cutter blade 1423 that has its cutting edge exposed to the outside of the clamping plates 1422. Further, the clamping plates 1422 can be conveniently detached from the mounting blocks 1421, facilitating replacement of the cutter blade 1423.

In this embodiment, the cutter sets 142 are arranged at two opposite lateral sides relative to the slit cutter 14, i.e., the slit cutter 14 can create a slit line al on the film roll/bags-on-a-roll A when it is rotated through one half turn.

Preferably, the slit line making mechanism 10 further comprises two supporting plates 16. Each supporting plate 16 comprises two mounting holes 161,162. The second roller 12 and the slit cutter 14 have the respective opposite ends thereof respectively pivotally coupled to the mounting holes 161,162 of the supporting plates 16. Thus, the supporting plates 16 can support rotation of the second roller 12 and the slit cutter 14 stably.

Further, the second roller 12 has the two opposite ends thereof respectively supported in respective second roller bearing assemblies 121 in the respective mounting holes 161 of the respective supporting plate 16; the slit cutter 14 has the two opposite ends thereof respectively supported in respective slit cutter bearing assemblies 143 in the respective mounting holes 162 of the respective supporting plate 16. Thus, the second roller 12 and the slit cutter 14 are steadily and rotatably supported between the supporting plates 16.

Further, the second roller 12 is coupled to the feeder motor 13 by a transmission belt 131; the slit cutter 14 is coupled to the slit cutter motor 15 by a transmission belt 151.

Referring to FIGS. 1-5, preferably, the slit line making mechanism 10 further comprises a third roller 17 disposed adjacent to the first roller 11 at, for example, the top side. The third roller 17 is selected from rubber or any other suitable material with a high friction coefficient. When the third roller 17 is peripherally pressed on the film roll/bags-on-a-roll A at the first roller 11, a friction force is created between the film roll/bags-on-a-roll A and the first roller 11, enabling the first roller 11 to deliver the film roll/bags-on-a-roll A to the reel replacement unit 20 accurately and positively.

Preferably, the slit line making mechanism 10 further comprises a bracket 18 and two power drives 19. The bracket 18 is connected with the third roller 17 and the first roller 11. The feeder motor 13 is controllable to rotate the second roller 12, causing the second roller 12 to rotate the first roller 11 by gear transmission. Rotating the first roller 11 causes rotation of the reel replacement unit 20 in moving the loaded reels B. The power drive 19 can be, for example, a pneumatic cylinder controllable to drive the bracket 18 in moving the first roller 11 into contact or away from the reel B at the reel replacement unit 20.

Further, the first roller 11 can be a hard roller, metal roller or steel roller, having a smooth surface that facilitates smoothening the film roll/bags-on-a-roll A during delivery. Thus, the first roller 11 has high wear resistance and high structural strength.

Further, the second roller 12 can be a hard roller, metal roller or steel roller, having high scratch resistance against the slit cutter 14.

As illustrated in FIGS. 1-6, the slit line making mechanism 10 is connected to one lateral side of the reel replacement unit 20. The reel replacement unit 20 comprises a rotating shaft 21, a plurality of discs 22, a plurality of reel holder components 23, and a reel replacement unit power drive 24. The discs 22 are mounted on the rotating shaft 21 and spaced along the length of the rotating shaft 21. The reel holder components 23 are equiangularly and symmetrically mounted on two opposing discs 22 for holding a predetermined number of reels B in an equiangularly spaced manner. The reel replacement unit power drive 24 is controllable to rotate the rotating shaft 21 step by step, cycling the respective reel holder components 23 in a proper order through a reel let-off position D1 for letting off the respective reel B, a reel-supplying position D2 for enabling the respective reel holder components 23 to receive a reel B, a film-rolling position D3 for enabling the respective reel B to roll up the film or bags-on-a-roll a from the film roll/bags-on-a-roll A, and a film-cutting position D4 for enabling the rolled-up film or bags-on-a-roll a to be cut off from the film roll/bags-on-a-roll A.

Subject to the control of the control unit, the film roll/bags-on-a-roll A, for example, wrap-on-a-roll is moved by the first roller 1 to the reel B1 at the reel replacement unit 20 in the reel-supplying position D2, enabling the lead end of the film roll/bags-on-a-roll A to be adhered to the reel B. Thereafter, the reel replacement unit power drive 24 moves the discs 22 to the film-rolling position D3 for enabling the respective reel B to roll up the film roll/bags-on-a-roll A. Rotating the discs 22 can move the reel holder components 23 to cycle the reels B one after another and step by step through the reel let-off position D1, the reel-supplying position D2, the film-rolling position D3 and the film-cutting position D4.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A slit line making mechanism, comprising:
a first roller;
a second roller disposed adjacent to one side of the first roller and rotatable to cause rotation of said first roller;
a feeder motor adapted for rotating said second roller;
a slit cutter disposed adjacent to one side of said second roller; and
a slit cutter motor adapted for rotating said slit cutter;
wherein said feeder motor is controllable to rotate said second roller and then said first roller after insertion of a lead end of a film roll/bags-on-a-roll through the gap between said first roller and said second roller and the gap between said second roller and said slit cutter, causing said film roll/bags-on-a-roll to be delivered to said reel replacement unit for dispensing; said feeder motor and said slit cutter motor are respectively and electrically connected to a control unit; said feeder motor is controllable by said control unit to rotate said second roller in delivering said film roll/bags-on-a-roll; said slit cutter motor is controllable by said control unit to rotate said slit cutter each time said second roller is rotated to deliver said film roll/bags-on-a-roll to a predetermined distance, causing said slit cutter to make a slit line on said film roll/bags-on-a-roll.

2. The slit line making mechanism as claimed in claim 1, wherein said feeder motor and said slit cutter motor are server motors.

3. The slit line making mechanism as claimed in claim 1, wherein said slit cutter comprises a cutter holder, and at least one cutter set fastened to said cutter holder.

4. The slit line making mechanism as claimed in claim 2, wherein said slit cutter comprises a cutter holder, and at least one cutter set fastened to said cutter holder.

5. The slit line making mechanism as claimed in claim 3, wherein each said cutter set comprises a plurality of mounting blocks fastened to the respective said cutter holder, two clamping plates detachably fastened to said mounting blocks, and a cutter blade mounted in between said clamping plates.

6. The slit line making mechanism as claimed in claim 4, wherein each said cutter set comprises a plurality of mounting blocks fastened to the respective said cutter holder, two clamping plates detachably fastened to said mounting blocks, and a cutter blade mounted in between said clamping plates.

7. The slit line making mechanism as claimed in claim 5, wherein said slit line making mechanism comprises two supporting plates, each said supporting plate comprising a plurality of mounting holes; said second roller and said slit cutter have respective opposite ends thereof respectively pivotally coupled to said mounting holes of said supporting plates.

8. The slit line making mechanism as claimed in claim 6, wherein said slit line making mechanism comprises two supporting plates, each said supporting plate comprising a plurality of mounting holes; said second roller and said slit cutter have respective opposite ends thereof respectively pivotally coupled to said mounting holes of said supporting plates.

9. The slit line making mechanism as claimed in claim 7, further comprising a plurality of roller bearing assemblies respectively mounted in said mounting holes of said support plates to support the respective opposite ends of said second roller and said slit cutter.

10. The slit line making mechanism as claimed in claim 8, further comprising a plurality of roller bearing assemblies respectively mounted in said mounting holes of said support plates to support the respective opposite ends of said second roller and said slit cutter.

11. The slit line making mechanism as claimed in claim 1, further comprising a third roller disposed adjacent to one side of said first roller and adapted for peripherally pressing on said film roll/bags-on-a-roll at said first roller.

12. The slit line making mechanism as claimed in claim 11, wherein said third roller is selected from rubber or a material with a high friction coefficient.

13. The slit line making mechanism as claimed in claim 11, further comprising a bracket and at least one power drive, said bracket being connected with said third roller and said first roller, said at least one power drive being controllable to drive said bracket in moving said first roller one of two reversed directions toward or away from a reel at said reel replacement unit.

14. The slit line making mechanism as claimed in claim 1, wherein said first roller and said second roller are selected from the group of hard rollers, metal rollers and steel rollers.
